(19) United States
(12) Patent Application Publication
(10) Pub. No.: US 2015/0009129 A1
(43) Pub. Date: Jan. 8, 2015

(54) METHOD FOR OPERATING PANORAMA IMAGE AND ELECTRONIC DEVICE THEREOF

(71) Applicant: Samsung Electronics Co., Ltd., Gyeonggi-do (KR)

(72) Inventors: Se-Jun SONG, Seoul (KR); Young-Keun CHOI, Gyeonggi-do (KR); Keum-Ju JANG, Seoul (KR)

(73) Assignee: Samsung Electronics Co., Ltd.

(21) Appl. No.: 14/321,382

(22) Filed: Jul. 1, 2014

(30) Foreign Application Priority Data
Jul. 8, 2013 (KR) 10-2013-0079634

(51) Int. Cl. G06F 1/16

(52) U.S. Cl. CPC G06F 1/1652
USPC 345/156

(57) ABSTRACT

A method for operating an electronic device is provided, which includes detecting bending of a flexible display, determining bending information corresponding to the bending, obtaining a plurality of images according to the detected bending information, and generating a panorama image by combining the obtained plurality of images. Thus, an intuitive user interface using the flexible display can be provided.

### PRIORITY

The present application claims priority under 35 U.S.C. §119(a) to a Korean Patent Application Serial No. 10-2013-0079634, filed in the Korean Intellectual Property Office on Jul. 8, 2013, the entire disclosure of which is incorporated herein by reference.

### BACKGROUND OF THE INVENTION

1. Field of Invention

The present invention relates generally to an electronic device and more particularly, to an electronic device for processing an image.

2. Description of Related Art

Electronic devices including flexible displays have recently drawn increasing attention. A flexible display may be employed in a device that traditionally uses a conventional display. For example, the flexible display may be applied to an e-Book and to an ultra-thin Personal Computer (PC), thereby allowing a user to fold or roll the flexible display.

With an expected increase of flexible displays, intuitive user interfaces will need to be developed for applying the flexible displays.

### SUMMARY OF THE INVENTION

To present invention has been made to address at least the above-discussed problems and disadvantages, and to provide at least the advantages described below. An aspect of the present invention is to provide a method for operating an electronic device to generate a panorama image.

Another aspect of the present invention is to provide a method for operating an electronic device including a flexible display.

Another aspect of the present invention is to provide a method for operating an electronic device to generate a panorama image to provide an intuitive user interface using a flexible display of the electronic device.

According to one aspect of the present invention, a method for operating an electronic device includes detecting bending of a flexible display; determining bending information; obtaining a plurality of images according to the determined bending information; and generating a panorama image by combining the obtained images.

According to another aspect of the present invention, a storage medium is provided for storing instructions, which when executed by at least one processor, make the at least one processor perform at least one operation. The at least one operation includes detecting bending of a flexible display, determining bending information of the flexible display, obtaining a plurality of images according to the determined bending information, and generating a panorama image by combining the obtained images.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram of an electronic device according to an embodiment of the present invention;

FIG. 2 is a block diagram of a processor according to an embodiment of the present invention;

FIG. 3 is a block diagram of a panorama image generator according to an embodiment of the present invention;

FIG. 4 is a flowchart of an operating method of the electronic device according to an embodiment of the present invention;

FIG. 5 is a flowchart of an operating method of the electronic device according to an embodiment of the present invention;

FIG. 6 is a flowchart of an operating method of the electronic device according to an embodiment of the present invention;

FIGS. 7A and 7B are illustrations of a camera device and a first image obtained for a panorama image through the camera device according to an embodiment of the present invention;

FIGS. 7C and 7D are illustrations of a camera device with a bended flexible display and a second image obtained for the panorama image through the camera device with the bended flexible display according to an embodiment of the present invention;

FIGS. 8A through 8D are illustrations of the panorama image generation according to an embodiment of the present invention;

FIG. 9 is a flowchart of an operating method of the electronic device according to an embodiment of the present invention;

FIGS. 10A through 10D are illustrations of the panorama image generation according to an embodiment of the present invention;

FIG. 11 is a flowchart of an operating method of the electronic device according to an embodiment of the present invention;

FIGS. 12A and 12B are illustrations of panorama image correction according to an embodiment of the present invention;

FIG. 13 is a flowchart of an operating method of the electronic device according to an embodiment of the present invention;

FIG. 14 is a flowchart of an operating method of the electronic device according to an embodiment of the present invention;

FIG. 15 is a flowchart of an operating method of the electronic device according to an embodiment of the present invention; and

FIGS. 16A and 16B are illustrations of a guide object displayed on a screen of an electronic device according to an embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of various embodiments of the invention as defined by the claims and their equivalents. The following description includes various specific details to assist in that understanding but these are to be regarded as merely illustrative. Accordingly, a person of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of certain embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, an electronic device including (or utilizing) a flexible display as its display is illustrated. For example, various electronic devices can employ the flexible display, e.g. Personal Digital Assistants (PDA), laptop computers, mobile phones, smart phones, netbooks, Mobile Internet Devices (MID), Ultra Mobile Personal Computers (UMPC), tablet PCs, navigation systems, and MP3 players.

The flexible display can be deformed using at least one of stretching, shrinking, bending, folding, twisting, and spreading, and components, including the flexible display, are able to handle such deformation.

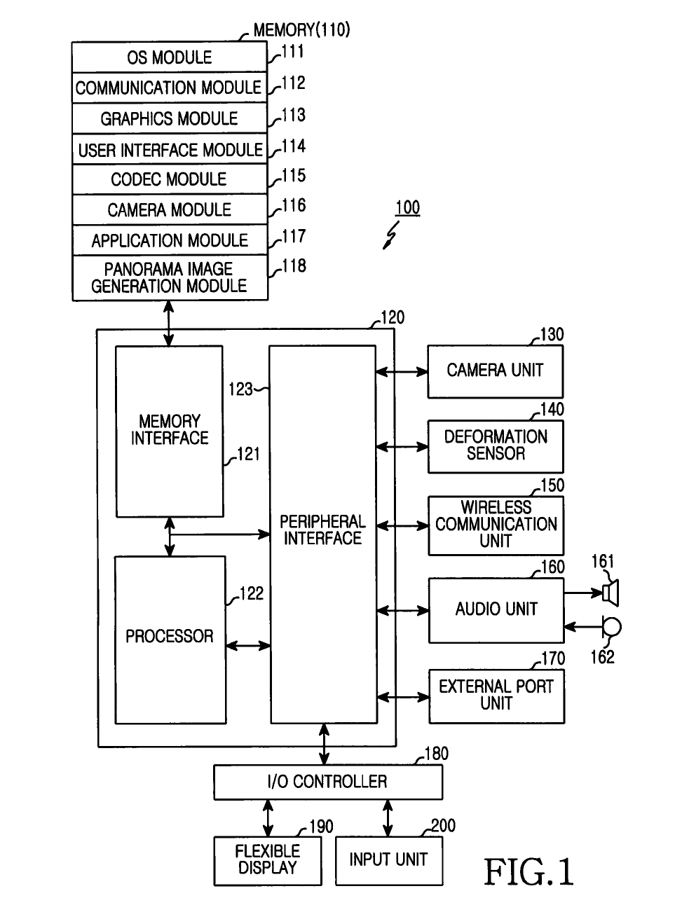

FIG. 1 is a block diagram of an electronic device according to an embodiment of the present invention.

Referring to FIG. 1, the electronic device 100, e.g. a mobile phone, a media player, a tablet computer, a handheld computer, a PDA, etc., The electronic device 100 includes a memory 110, a processor unit 120, a camera device 130, a deformation sensor 140, a wireless communication device 150, an audio device 160, an external port device 170, an input/output controller 180, a flexible display 190, and an input device 200. A plurality of memories 110 and a plurality of external port devices 170 can be used.

The processor unit 120 includes a memory interface 121, at least one processor 122, and a peripheral interface 123. Herein, the memory interface 121, the at least one processor 122, and the peripheral interface 123 of the processor unit 120 can be integrated onto at least one integrated circuit or implemented as separate components.

The memory interface 121 controls access of the component such as processor 122 or peripheral interface 123, to the memory 110.

The peripheral interface 123 controls a connection between an input/output peripheral of the electronic device 100, and the processor 122 and the memory interface 121.

The processor 122 controls the electronic device 100 to provide various multimedia services using at least one software program. In so doing, the processor 122 executes at least one program stored in the memory 110 and provides a service of the corresponding program.

The processor 122 performs various functions for the electronic device 100 by running various software programs and processes and controls voice communication, video communication, and data communication.

The processor 122 implements the method of the present invention using software modules stored in the memory 110. The electronic device 100 can include one or more data processors, an image processor, or a CODEC. The electronic device 100 may include the data processors, the image processor, or the CODEC individually.

The camera device 130 performs camera functions such as photo and video clip recording. The camera device 130 includes a Charged Coupled Device (CCD) or a Complementary Metal-Oxide Semiconductor (CMOS). According to a camera program executed by the processor 122, the camera device 130 modifies a hardware structure, for example, moves a lens or adjusts an f-number of an iris.

The camera device 130 provides the processor unit 120 with an image obtained by capturing an object. The camera device 130 includes a camera sensor for converting an optical signal to an electric signal, an image processor for converting an analog image signal to a digital image signal, and a signal processor for processing the image signal output from the image processor to be displayed by the flexible display 190. The camera device 130 may be attached or mounted to a certain region of the flexible display 190, and an Angle Of View (AOV) can vary according to the type of the flexible display 190.

The various components of the electronic device 100 can be coupled using one or more communication buses or electrical connectors.

The deformation sensor 140 includes at least one sensor for detecting deformation of the flexible display 190. The deformation sensor 140 can be attached or mounted to a certain region of the flexible display 190. The deformation indicates at least one of stretching, shrinking, bending, folding, twisting, and spreading. For example, the deformation sensor 140 can include a bending sensor for determining bending information or twisting information of the flexible display 190, or an acceleration sensor for detecting a dynamic force such as acceleration, vibration, or shock and adopting inertial force, electrostrictive, and gyro principles. The bending information includes at least one bending type, a bending degree, or a bending direction, and the twisting information includes at least one twist type, a twist degree, or a twist direction.

The bending sensor includes at least one pair of electrode patterns spaced on a flexible board, and a paste layer including conductive particles and sprayed on the flexible board, including the electrode patterns. When the flexible board bends, the density of the conductive particles between the electrode patterns varies to change the electric resistance between the electrode patterns. By use of such a bending sensor, the deformation sensor 140 determines and provides the bending information or the twisting information of the flexible display 190, to the processor 122.

The acceleration sensor includes acceleration sensors (e.g., an X-axis acceleration sensor, a Y-axis acceleration sensor, and a Z-axis acceleration sensor) in three orthogonal directions (e.g., X axis, Y axis, and Z axis). The acceleration sensor calculates a pitch angle or a roll angle based on voltage values measured by the axis acceleration sensors and thus measures a change in tilt of the flexible display 190.

The wireless communication device 150 controls wireless communication and can include a radio frequency transmitter and receiver or an optical (e.g., infrared light) transmitter and receiver. Depending on a communication network, the wireless communication device 150 can be designed to operate over one or more of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, a WiMax network and a Bluetooth network.

The audio device 160 is coupled to a speaker 161 and a microphone 162 to process audio input and output such as voice recognition, voice reproduction, digital recording, and telephone functionality. The audio device 160 provides an audio interface between the user and the electronic device 100, receives a data signal with the processor unit 120, converts the received data signal to an electric signal, and outputs the converted electric signal to the speaker 161.

The speaker 161 converts and outputs the electric signal in an audible frequency band, and can be disposed at the back of the electronic device 100. The speaker 161 can include a flexible film speaker which attaches at least one piezoelectric material to one vibration film.

The microphone 162 converts a sound wave from a person or other sound sources to an electric signal. The audio device 160 receives the electric signal from the microphone 162, converts the received electric signal to the audio data signal, and sends the converted audio data signal to the processor unit 120. The audio device 160 can include an ear phone, head phone, or head set attachable and detachable to and from the electronic device 100.

The external port device 170 connects the electronic device 100 to other electronic devices directly or indirectly via the network (e.g., Internet, intranet, and wireless LAN).

The input/output controller 180 provides an interface between the input/output device such as flexible display 190 and input device 200, and the peripheral interface 123.

The flexible display 190 displays the signal fed from the processor unit 120 as an image, such as text, graphics, and video. The flexible display 190 displays status information of the electronic device 100 and a character, a moving picture, or a still picture input by the user. The flexible display 190 displays application information driven by the processor 122.

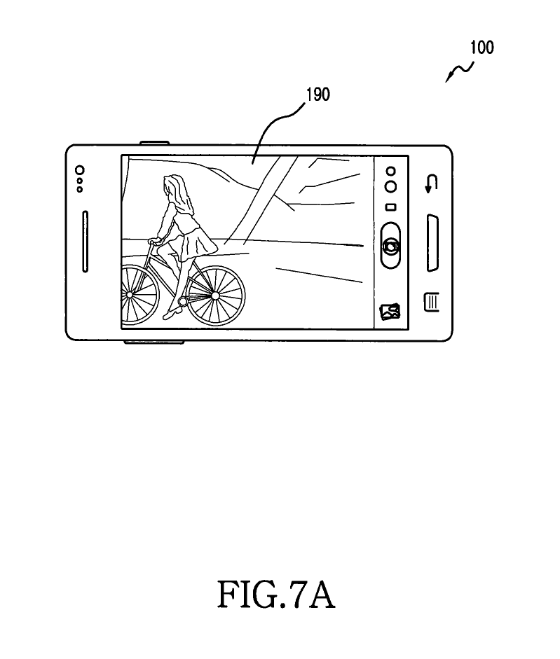

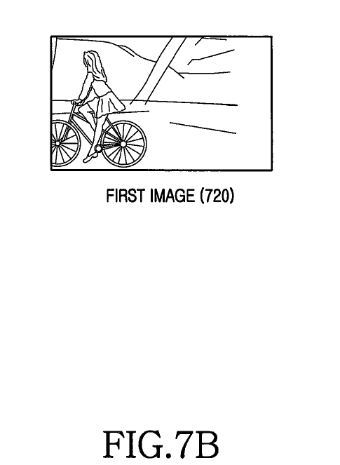

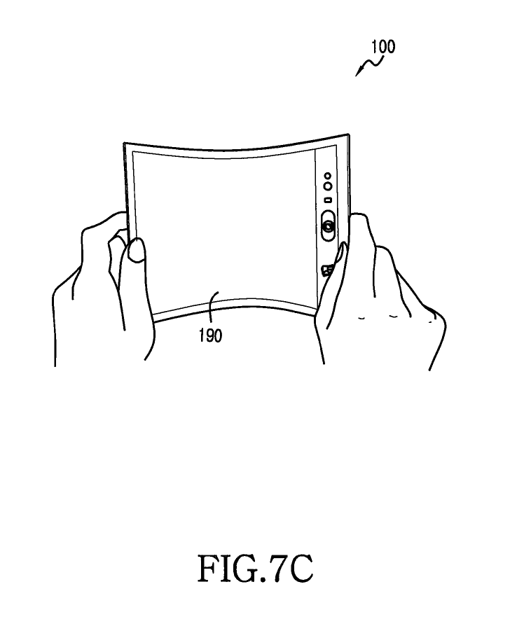

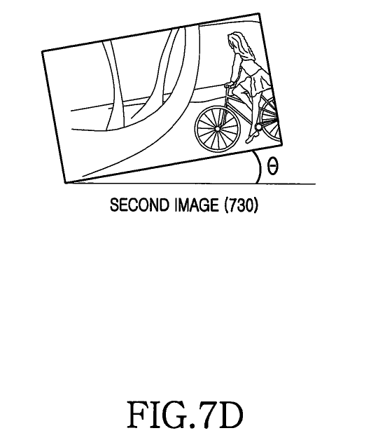

The flexible display 190 can be deformed using at least one of stretching, shrinking, bending, folding, twisting, and spreading. Accordingly, the electronic device 100, including the flexible display 190 can bend as shown in FIG. 7C. The flexible display 190 can include a dual-sided display for monitoring two sides, and apply a touch screen technique.

The input device 200 provides input data generated by a user's selection to the processor 122 via the input/output controller 180. In so doing, the input device 200 can include a keypad including at least one hardware button, and a touch pad for detecting touch information. The input device 200 can include up/down buttons for volume control. Besides, the input device 200 can include at least one of a push button, a rocker button, a rocker switch, a thumb wheel, a dial, a stick, and a pointer such as stylus, which is given a corresponding function.

The memory 110 can include fast random access memory, such as one or more magnetic disc storage devices and non-volatile memory, one or more optical storage devices, or a flash memory (e.g., NAND and NOR). The memory 110 stores software, and the software can include an operating system module 111, a communication module 112, a graphic module 113, a user interface module 114, a CODEC module 115, a camera module 116, one or more application modules 117, and a panorama image generation module 118. The term ‘module’ may refer to a set of instructions, an instruction set, or a program.

The operating system module 111 includes an embedded operating system, such as WINDOWS, LINUX, Darwin, RTXC, UNIX, OS X, or VxWorks, and includes various software components for controlling general system operations. These include, e.g., memory management and control, storage hardware (device) control and management, and power control and management. The operating system module 111 also processes normal communication between various hardware (devices) and software components (modules).

The communication module 112 communicates with other electric devices, such as computers, servers, and electronic devices, through the wireless communication device 150 or the external port device 170.

The graphic module 113 includes various software components for providing and displaying graphics on the flexible display 190. The term ‘graphics’ encompasses text, web page, icon, digital image, video, and animation.

The user interface module 114 includes various software components relating to the user interface. The user interface module 114 controls the flexible display 190 to display the application information driven by the processor 122. For example, when the processor 122 executes the panorama image generation module 118, the user interface module 114 controls to display the image captured by the camera device 130 on the flexible display 190. The user interface module 114 is involved in the status change of the user interface and the condition of the user interface status change.

The CODEC module 115 includes software components relating to video file encoding and decoding.

The camera module 116 includes camera related software components allowing camera related processes and functions.

The application module 117 includes software components for at least one application installed to the electronic device 100. The application can include a browser, an e-mail, a phonebook, a game, a short message service, a multimedia message service, an instant message, a wakeup call, an MPEG Layer 3 (MP3), schedule management, a camera, a word processing, keyboard emulation, an address book, a touch list, a widget, Digital Right Management (DRM), voice recognition, voice reproduction, a position determining function, and a location based service. The application module 117 can include a process for such various services, and various routines for supporting and operating the applications.

The panorama image generation module 118 includes at least one software component for generating the panorama image using the images obtained by the camera device 130. The panorama image generation module 118 includes a process for the panorama image and various routines for supporting and operating the panorama image.

The processor unit 120 can further include additional modules (instructions) besides the above-stated modules. The various functions of the electronic device 100 can include hardware or software, including one or more processors or Application Specific Integrated Circuits (ASICs).

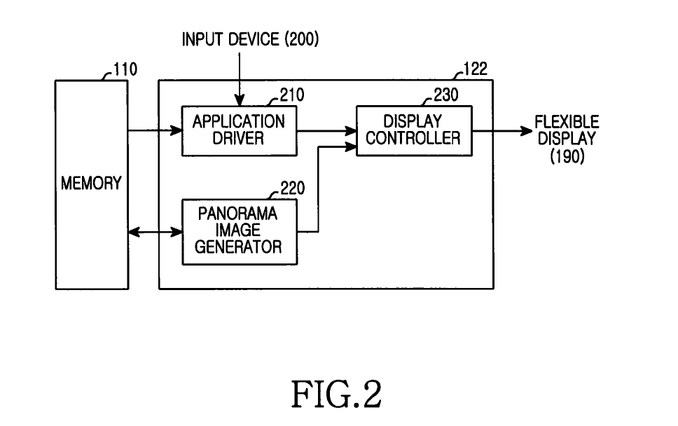

FIG. 2 is a block diagram of the processor according to an embodiment of the present invention.

Referring to FIG. 2, the processor 122 includes an application driver 210, a panorama image generator 220, and a display controller 230. While the components of the processor 122 can be implemented using separate modules, they can also be implemented as software components using a single module.

The application driver 210 executes at least one application module 117 stored in the memory 110 and provides the service of the corresponding application. In so doing, the application driver 210 drives the panorama image generator 220 according to service characteristics.

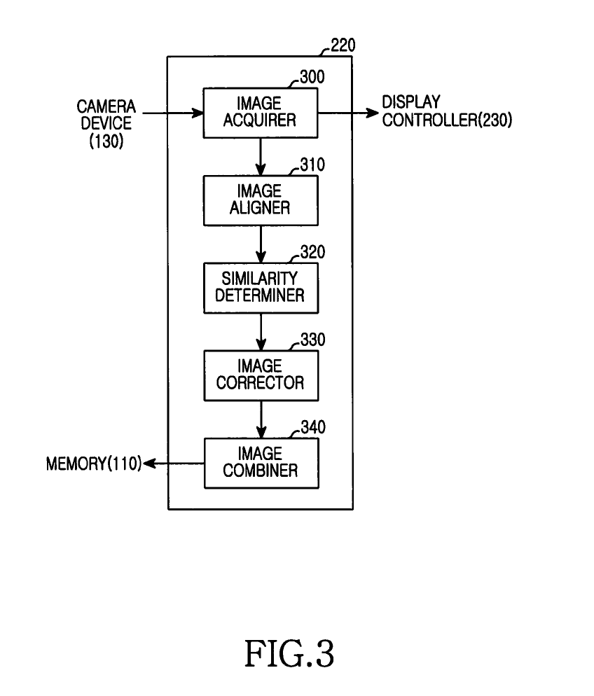

The panorama image generator 220 generates the panorama image by executing the panorama image generation module 118 stored in the memory 110. For example, the panorama image generator 220 includes an image acquirer 300, an image aligner 310, a similarity determiner 320, an image corrector 330, and an image combiner 340 as shown in FIG. 3.

The image acquirer 300 receives a plurality of images for the panorama image from the camera device 130. The camera device 130 can be disposed at the back of the electronic device 100. The electronic device 100 acquires a first image 720 for the panorama image through the camera device 130 as shown in FIGS. 7A and 7B. The electronic device 100 can acquire a second image 730 for the panorama image in the bended flexible display 190 as shown in FIGS. 7C and 7D. The second image 730 can be rotated at a certain angle θ when the flexible display 190 bends. This is because the AOV of the camera device 130 changes when the flexible display 190 bends.

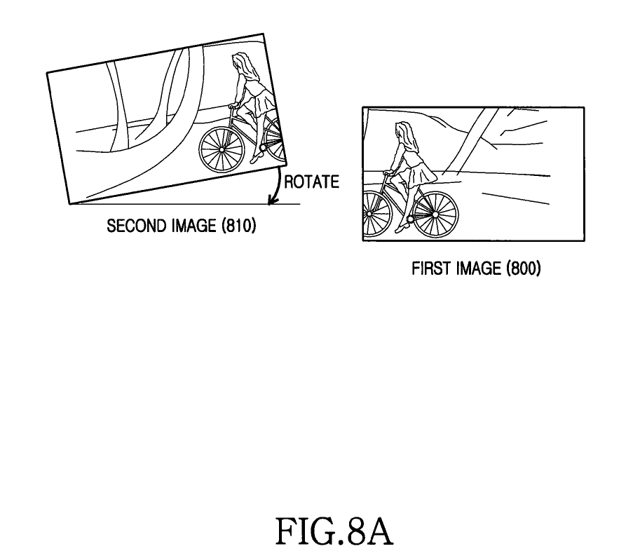

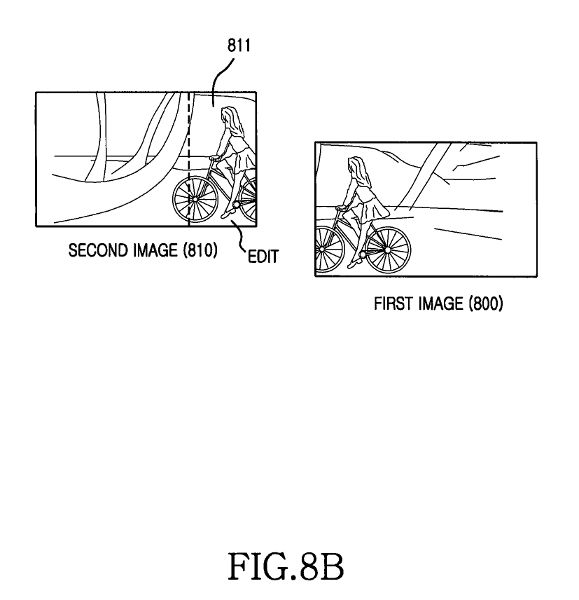

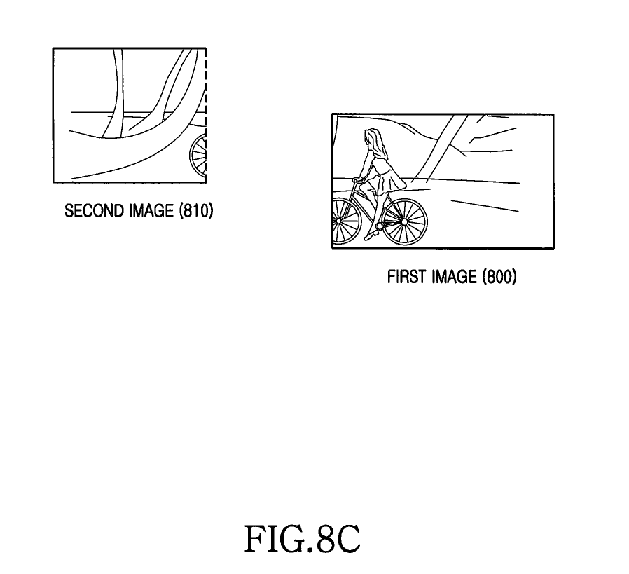

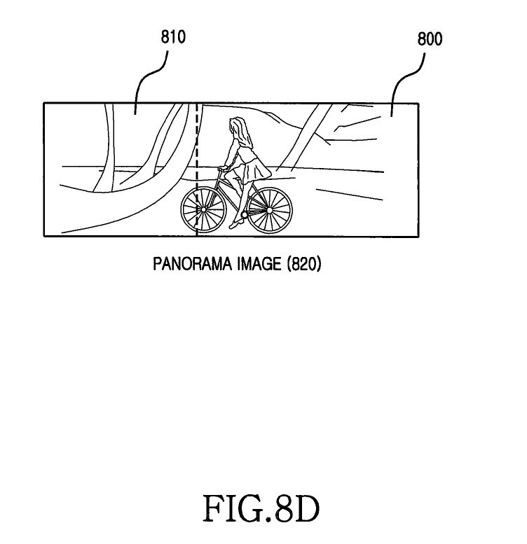

The image aligner 310 aligns at least one image obtained for the panorama image. The image aligner 310 rotates a second image 810 at a certain angle based on a first image 800 as shown in FIGS. 8A and 8B. In so doing, the image aligner 310 rotates the second image 810 at a certain angle by considering the bending information or the twisting information of the flexible display 190 when the electronic device 100 captures the second image 810.

The similarity determiner 320 determines similarity of at least one image obtained for the panorama image. The similarity determiner 320 determines the similarity of the second image 810 with the first image 800 based on similarity criteria as shown in FIG. 8B. Using a block matching algorithm, the similarity determiner 320 determines whether the second image 810 and the first image 800 include an overlapping part 811.

The image corrector 330 corrects or edits at least one image acquired for the panorama image. The image corrector 330 cuts or deletes the overlapping part 811 in the second image 810 as shown in FIGS. 8B and 8C.

The image combiner 340 combines the images for the panorama image. The image combiner 340 combines the second image 810 and the first image 800, as shown in FIG. 8D, by applying k-means clustering. The image combiner 340 may combine the second image 810 and the first image 800 using a stitching program stored in the memory 110. Thus, the image combiner 340 creates a panorama image 820.

The display controller 230 controls to display the graphic user interface on the flexible display 190 by executing the user interface module 114 stored in the memory 110. The display controller 230 controls to display the application information driven by the application driver 210 on the flexible display 190.

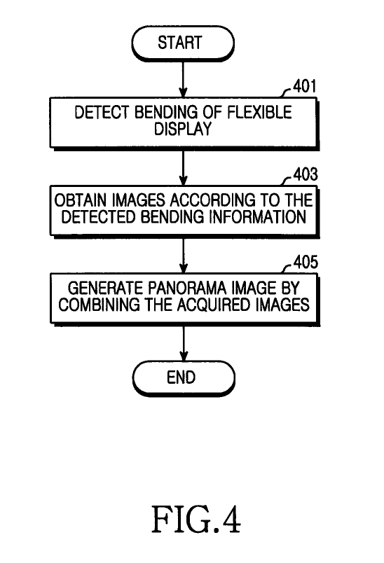

FIG. 4 is a flowchart of an operating method of the electronic device according to an embodiment of the present invention.

Referring to FIG. 4, the deformation sensor 140 of the electronic device 100 detects the bending of the flexible display 190 (as described above) in step 401. When detecting the bending, the electronic device 100 obtains a plurality of images according to the detected bending information in step 403. The bending information can include at least one bending type, bending degree, or bending direction. The camera device 130 can be disposed at the back of the electronic device 100, and acquire the plurality of the images. When the flexible display 190 is bent inward or outwards as shown in FIG. 7C, the AOV of the camera device 130 can vary. For example, when the user grabs the electronic device 100 with both hands and bends the flexible display 190 inward with the left hand, the electronic device 100 can acquire a plurality of images of the object on the left side of the camera. In step 405, the electronic device 100 generates the panorama image by combining the acquired images. For example, the electronic device 100 can generate the panorama image by combining the images using the k-means clustering. For example, the electronic device 100 can generate the panorama image by combining the images using the stitching program stored in the memory 110.

Instruction sets for this method can be stored as one or more modules in the memory 110. In this case, the module stored in the memory 110 can be executed by one or more processors 122.

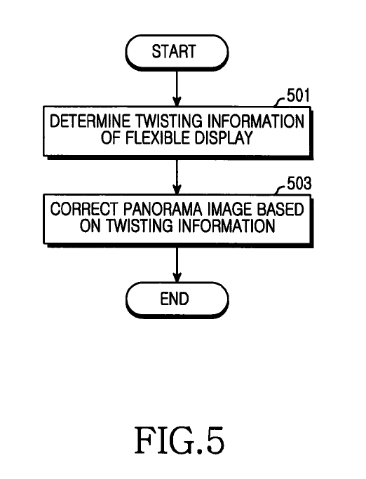

FIG. 5 is a flowchart of an operating method of the electronic device according to an embodiment of the present invention.

Referring to FIG. 5, the deformation sensor 140 of the electronic device 100 determines the twisting information of the flexible display 190 (as described above) in step 501. The twisting information can include at least one twist type, twist degree, or twist direction. In step 503, the electronic device 100 corrects the panorama image based on the twisting information. For example, the electronic device 100 corrects at least one second image 810 for the panorama image as shown in FIG. 8A. The electronic device 100 rotates the second image 810 at a certain angle based on the first image 800. In so doing, the electronic device 100 rotates the second image 810 at a certain angle by considering the twisting information of the flexible display 190 when the electronic device 100 captures the second image 810.

Instruction sets for this method can be stored as one or more modules in the memory 110. In this case, the module stored in the memory 110 can be executed by one or more processors 122.

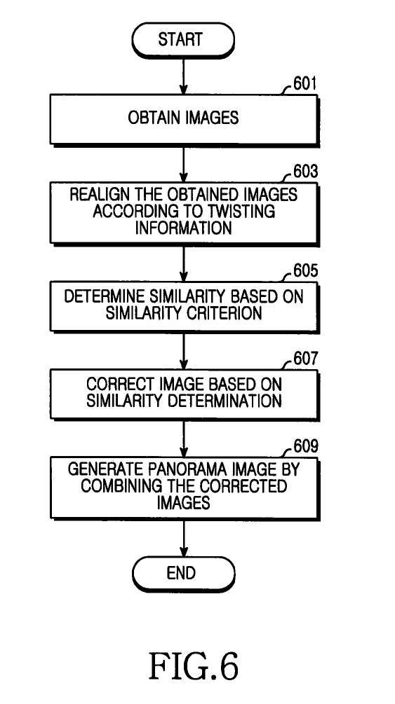

FIG. 6 is a flowchart of an operating method of the electronic device according to an embodiment of the present invention.

Referring to FIG. 6, the electronic device 100 obtains a plurality of images in step 601. For example, the electronic device 100 receives the images for the panorama image captured by the camera device 130. The electronic device 100 acquires the first image 720 for the panorama image through the camera device 130 as shown in FIGS. 7A and 7B. The electronic device 100 acquires the second image 730 for the panorama image in the bended flexible display 190 as shown in FIGS. 7C and 7D. The second image 730 can be rotated at a certain angle θ when the flexible display 190 bends because the AOV of the camera device 130 changes when the flexible display 190 bends.

In step 603, the electronic device 100 realigns the obtained images according to the twisting information. The electronic device 100 corrects the second image 810 at a certain angle based on the first image 800 as shown in FIGS. 8A and 8B. In so doing, the electronic device 100 rotates the second image 810 at a certain angle by considering the twisting information of the flexible display 190 when the electronic device 100 captures the second image 810. The twisting information can include at least one twist type, the twist degree, or the twist direction.

In step 605, the electronic device 100 determines the similarity based on the similarity criterion. The electronic device 100 determines the similarity of the second image 810 with the first image 800 based on the similarity criteria as shown in FIG. 8B. Using the block matching algorithm, the electronic device 100 determines whether the second image 810 and the first image 800 include the overlapping part 811.

In step 607, the electronic device 100 corrects the image based on the similarity determination. The electronic device 100 cuts or deletes the overlapping part 811 in the second image 810 as shown in FIGS. 8B and 8C.

In step 609, the electronic device 100 generates the panorama image by combining the corrected images. For example, the electronic device 100 combines the second image 810 and the first image 800 using the k-means clustering. For example, the electronic device 100 combines the second image 810 and the first image 800 using the stitching program stored in the memory 110. Thus, the electronic device 100 creates the panorama image 820.

Instruction sets for this method can be stored as one or more modules in the memory 110. In this case, the module stored in the memory 110 can be executed by one or more processors 122.

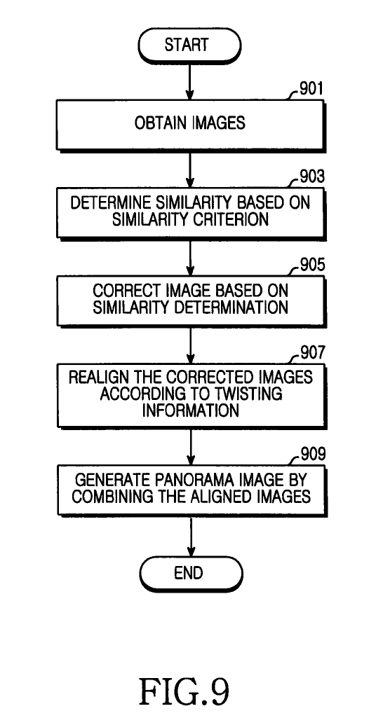

FIG. 9 is a flowchart of an operating method of the electronic device according to an embodiment of the present invention.

Referring to FIG. 9, the electronic device 100 obtains a plurality of images in step 901. For example, the electronic device 100 receives the images for the panorama image captured by the camera device 130. The electronic device 100 acquires the first image 720 for the panorama image through the camera device 130 as shown in FIGS. 7A and 7B. The electronic device 100 acquires the second image 730 for the panorama image in the bended flexible display 190 as shown in FIGS. 7C and 7D. The second image 730 can be rotated at a certain angle θ when the flexible display 190 bends. This is because the AOV of the camera device 130 changes when the flexible display 190 bends.

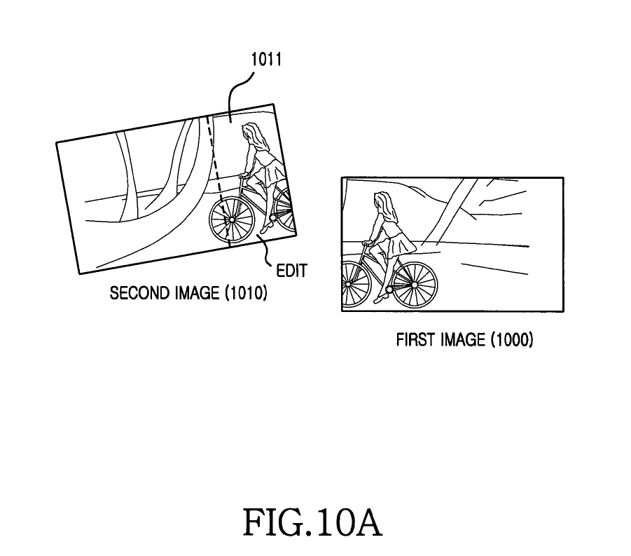

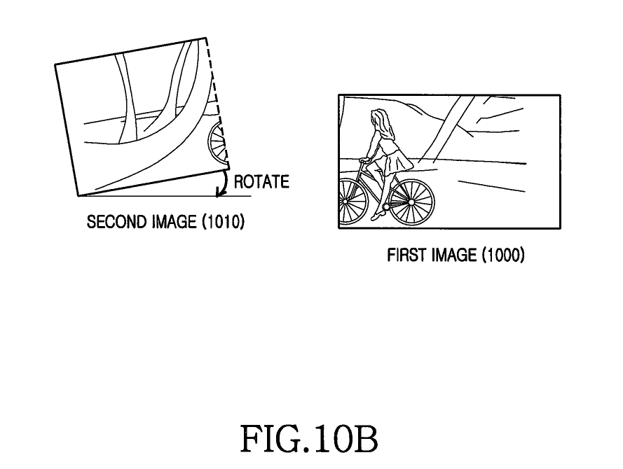

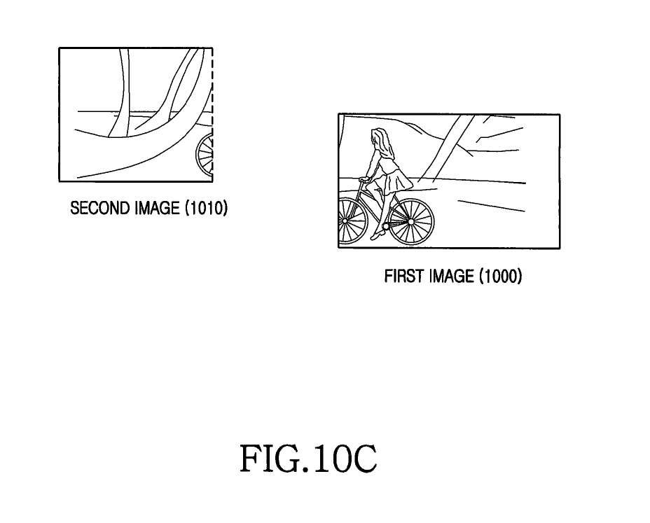

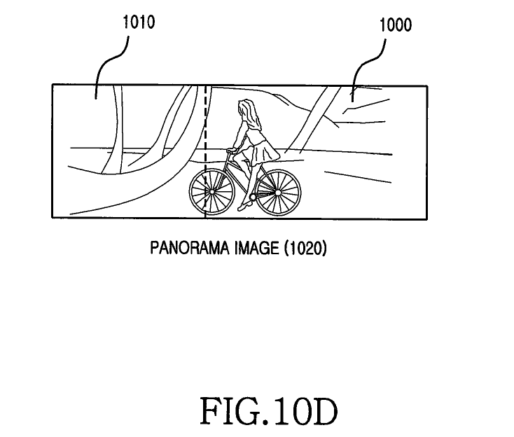

In step 903, the electronic device 100 determines the similarity based on the similarity criterion. The electronic device 100 can determine the similarity of a second image 1010 with a first image 1000 based on the similarity criteria as shown in FIG. 10A. Using the block matching algorithm, the electronic device 100 determines whether the second image 1010 and the first image 1000 include an overlapping part 1011.

In step 905, the electronic device 100 corrects the image based on the similarity determination. For example, the electronic device 100 cuts or deletes the overlapping part 1011 in the second image 1010 as shown in FIGS. 10A and 10B.

In step 907, the electronic device 100 realigns the corrected images according to the twisting information. For example, the electronic device 100 rotates the second image 1010 at a certain angle based on the first image 1000 as shown in FIGS. 10B and 10C. In so doing, the electronic device 100 rotates the second image 1010 at a certain angle by considering the twisting information of the flexible display 190 when the electronic device 100 captures the second image 1010. The twisting information can include at least one twist type, the twist degree, or the twist direction.

In step 909, the electronic device 100 generates the panorama image by combining the aligned images. For example, the electronic device 100 can combine the second image 1010 and the first image 1000 using the k-means clustering as shown in FIG IOD. For example, the electronic device 100 may combine the second image 1010 and the first image 1000 using the stitching program stored in the memory 110. Thus, the electronic device 100 creates a panorama image 1020.

Instruction sets for this method can be stored as one or more modules in the memory 110. In this case, the module stored in the memory 110 can be executed by one or more processors 122.

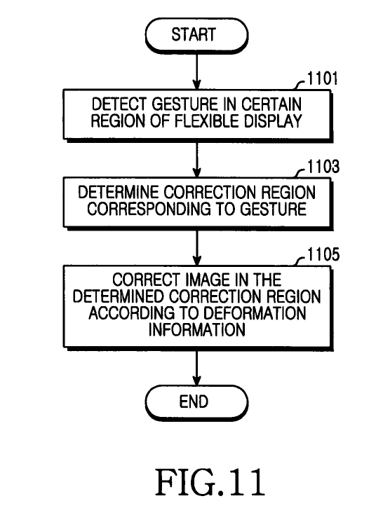

FIG. 11 is a flowchart of an operating method of the electronic device according to an embodiment of the present invention.

Referring to FIG. 11, the electronic device 100 detects a gesture in a region of the flexible display 190 in step 1101. The gesture can indicate a touch pattern in the flexible display 190 of the electronic device 100. The touch is applied to the flexible display of the electronic device 100 by an external input means, such as a user's finger or a touch pen, and the gesture can indicate dragging in a certain pattern while still touching the flexible display 190. In some cases, the gesture can indicate the touch-and-drag and the touch release. The gesture can include, for example, tapping, touching and holding, double tapping, dragging, panning, flicking, or dragging and dropping.

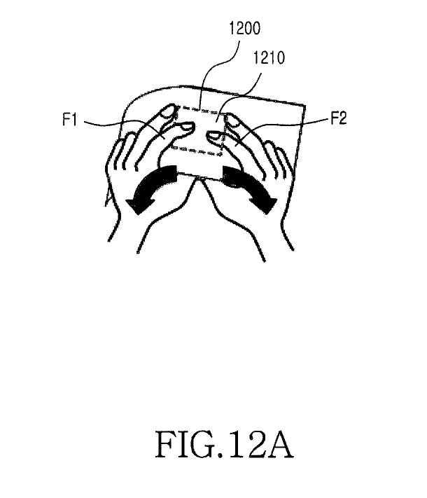

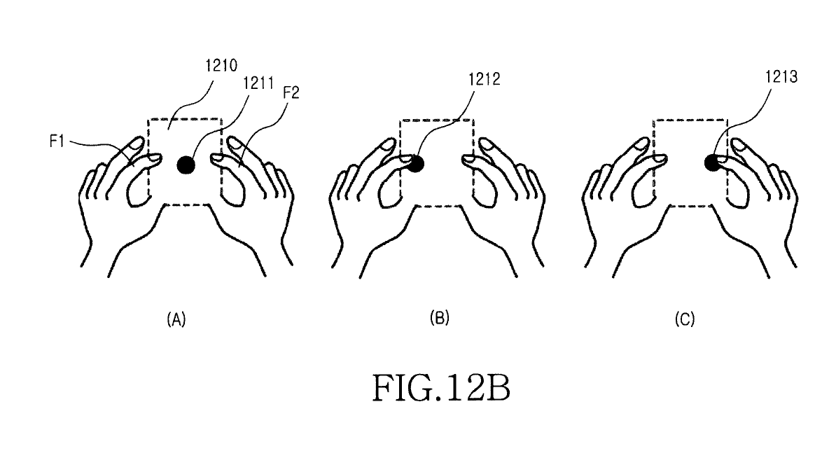

As shown in FIG. 12A, the gesture can be a closed curve 1200 drawn of a certain size, with fingers F1 and F2 or an input means such as touch pen, in a certain area of the flexible display 190. The electronic device 100 determines the closed curve 1200 only when the closed curve 1200 includes at least one screen edge.

In step 1103, the electronic device 100 determines a correction region corresponding to the gesture. For example, the electronic device 100 recognizes a closed curve 1200 of a certain size as shown in FIG. 12A. The electronic device 100 determines an area inside the closed curve 1200 as the correction region 1210.

In step 1105, the electronic device 100 corrects an image in the determined correction region according to the deformation information. For example, the deformation information can include information relating to at least one of stretching, shrinking, bending, folding, twisting, and spreading of the flexible display 190. The deformation information is acquired by the deformation sensor 140. The electronic device 100 corrects the image in the correction region 1210 by bending or stretching the determined correction region 1210 as shown in FIG. 12B. The electronic device 100 corrects the image in the correction region based on a reference point of the correction region 1210. For example, in (A) of FIG. 12B, the reference point 1211 can be a midpoint between touch points of the left hand F1 and the right hand F2. The reference point may be the first touch point 1212 as shown in (B) of FIG. 12B or the second touch point 1213 as shown in (C) of FIG. 12B.

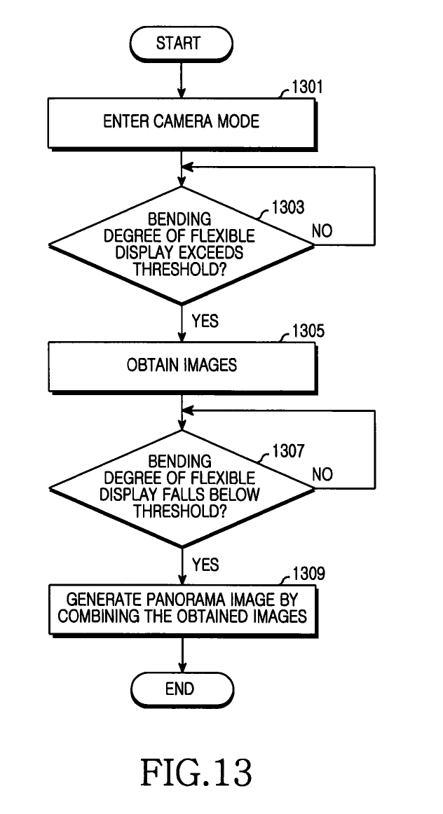

FIG. 13 is a flowchart of an operating method of the electronic device according to an embodiment of the present invention.

Referring to FIG. 13, the electronic device 100 enters a camera mode in step 1301. In the camera mode, the electronic device 100 runs the camera application stored in the memory 110 or captures the image through the camera device 130.

In step 1303, the electronic device 100 determines whether the bending degree of the flexible display 190 exceeds a threshold. For example, the bending degree of the flexible display 190 is measured by the deformation sensor 140.

When the bending degree of the flexible display 190 exceeds the threshold, the electronic device 100 obtains a plurality of images in step 1305. For example, the electronic device 100 can obtain continuous images based on the AOV which varies according to the bending degree of the flexible display 190.

In step 1307, the electronic device 100 determines whether the bending degree of the flexible display 190 falls below the threshold.

When the bending degree of the flexible display 190 falls below the threshold, the electronic device 100 generates the panorama image by combining the acquired images in step 1309. For example, the electronic device 100 can generate the panorama image by combining the images using the k-means clustering. For example, the electronic device 100 may generate the panorama image by combining the images using the stitching program stored in the memory 110.

Instruction sets for this method can be stored as one or more modules in the memory 110. In this case, the module stored in the memory 110 can be executed by one or more processors 122.

Alternatively, the electronic device 100 can recognize that the panorama image creation starts when the bending degree of the flexible display 190 exceeds the threshold. In such a case, the electronic device 100 recognizes that the panorama image creation ends when the bending degree of the flexible display 190 falls below the threshold. For example, the electronic device 100 can display the images acquired in the panorama image creation initiation on the screen, and generate the panorama image with the acquired images in real time.

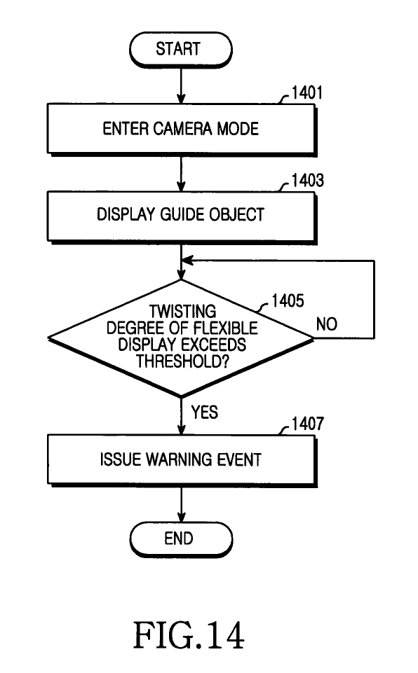

FIG. 14 is a flowchart of an operating method of the electronic device according to an embodiment of the present invention.

Referring to FIG. 14, the electronic device 100 enters the camera mode in step 1401. In the camera mode, the electronic device 100 runs the camera application stored in the memory 110 or captures the image through the camera device 130.

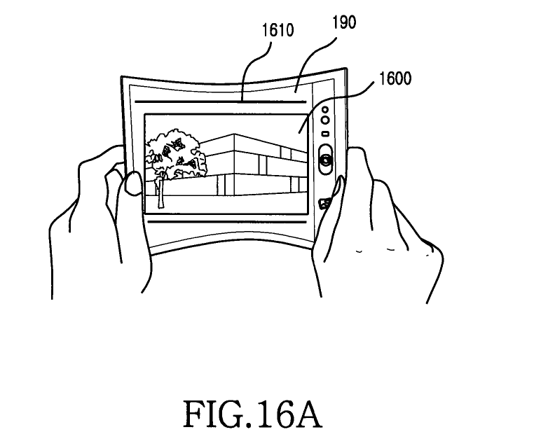

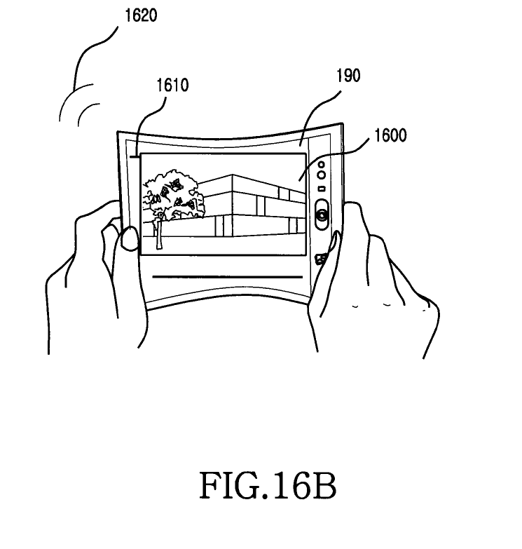

In step 1403, the electronic device 100 displays a guide object. The electronic device 100 displays a guide object 1610 in a background image 1600 as shown in FIG. 16A. The guide object 1610 can include at least one line, character, or particular shape. The guide object 1610 prevents a distorted image from being generated by the twisted flexible display 190. For example, the guide object 1610 guides the background image 1600 to lie within the guide object 1610 and thus generate the desirable background image 1600.

In step 1405, the electronic device 100 determines whether the twisting degree of the flexible display 190 exceeds a threshold. The twisting degree of the flexible display 190 is measured by the deformation sensor 140.

When the twisting degree of the flexible display 190 exceeds the threshold, the electronic device 100 issues a warning event in step 1407. In this case, the background image 1600 hides at least part of the guide object 1610 as shown in FIG. 16B. The warning event 1620 can output at least one of vibration, a Light Emitting Diode (LED), a text, and an image, and voice data.

Instruction sets for this method can be stored as one or more modules in the memory 110. In this case, the module stored in the memory 110 can be executed by one or more processors 122.

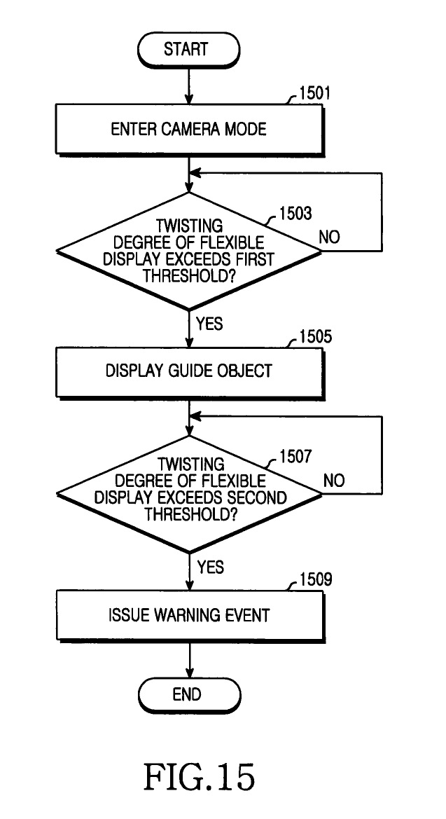

FIG. 15 is a flowchart of an operating method of the electronic device according to an embodiment of the present invention.

Referring to FIG. 15, the electronic device 100 enters the camera mode in step 1501. In the camera mode, the electronic device 100 runs the camera application stored in the memory 110 or captures the image through the camera device 130.

In step 1503, the electronic device 100 determines whether the twisting degree of the flexible display 190 exceeds a first threshold. The twisting degree of the flexible display 190 is detected by the deformation sensor 140.

When the twisting degree of the flexible display 190 exceeds the first threshold, the electronic device 100 display the guide object in step 1505. The electronic device 100 displays the guide object 1610 in the background image 1600 as shown in FIG. 16A. The guide object 1610 can include at least one line, character, or particular shape. The guide object 1610 prevents the distorted image from being generated by the twisted flexible display 190. For example, the guide object 1610 can guide the background image 1600 to lie within the guide object 1610 and thus generate the desirable background image 1600.

In step 1507, the electronic device 100 determines whether the twisting degree of the flexible display 190 exceeds a second threshold.

When the twisting degree of the flexible display 190 exceeds the second threshold, the electronic device 100 issues a warning event in step 1509. In this case, the background image 1600 hides at least part of the guide object 1610 as shown in FIG. 16B. The warning event 1620 can output at least one vibration, LED, a text, an image, and voice data.

Instruction sets for this method can be stored as one or more modules in the memory 110. In this case, the module stored in the memory 110 can be executed by one or more processors 122.

According to various embodiments of the present invention, the above-described modules can be implemented in software, firmware, hardware, or in their combinations. Part or all of the modules can be constructed as a single unit to fulfill the same functions of the modules. Their operations can be conducted sequentially, repeatedly, or in parallel. Some operations can be omitted or other operations can be added. For example, the operations can be carried out by the corresponding module of the present invention.

As for the software, a computer-readable storage medium storing one or more programs (software modules) can be provided. One or more programs stored in the computer-readable storage medium can be configured for execution by one or more processors of the electronic device. One or more programs can include instructions for controlling the electronic device to execute the methods according to the exemplary embodiments of the present invention.

Such a program (software module, software) can be stored to a random access memory, a non-volatile memory including a flash memory, a Read Only Memory (ROM), an Electrically Erasable Programmable ROM (EEPROM), a magnetic disc storage device, a Compact Disc (CD)-ROM, Digital Versatile Discs (DVDs) or other optical storage devices, and a magnetic cassette. Alternatively, the programs can be stored to a memory combining part or all of those recording media. A plurality of memories may be equipped.

The programs can be stored in an attachable storage device accessible via a communication network such as Internet, Intranet, Local Area Network (LAN), Wide LAN (WLAN), or Storage Area Network (SAN), or a communication network by combining these networks. The storage device can access the electronic device through an external port. A separate storage device may access the electronic device over the communication network.

As set forth above, the method for operating the panorama image and the electronic device thereof provides an intuitive user interface by adopting the flexible display.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method in an electronic device, the method comprising:
detecting a bending of a flexible display;
determining bending information corresponding to the detected bending;
obtaining a plurality of images according to the determined bending information; and
generating a panorama image by combining the obtained plurality of images.

2. The method of claim 1, wherein the bending of the flexible display is detected by a deformation sensor which includes at least one acceleration sensor or a bending sensor.

3. The method of claim 1, wherein the bending information comprises at least one of a bending type, a bending degree, or a bending direction of the flexible display.

4. The method of claim 1, wherein generating the panorama image comprises applying k-means clustering or a stitching program.

5. The method of claim 1, further comprising correcting the obtained plurality of images.

6. The method of claim 5, wherein correcting the obtained plurality of images comprises:
determining twisting information of the flexible display when the plurality of images are captured; and
realigning the plurality of images according to the determined twisting information.

7. The method of claim 6, wherein the twisting information comprises at least one of a twist type, a twist degree, or a twist direction of the flexible display.

8. The method of claim 6, wherein the twisting information of the flexible device is detected by a deformation sensor.

9. The method of claim 1, further comprising correcting the generated panorama image.

10. The method of claim 9, wherein correcting the generated panorama image comprises:
detecting a gesture in a certain region of the panorama image;
determining a correction region corresponding to the detected gesture; and
correcting a part of the panorama image in the determined correction region according to deformation information of the flexible display.

11. The method of claim 10, wherein the gesture includes any one of tapping, touching and holding, double tapping, dragging, panning, flicking, and dragging and dropping, to the part of the panorama image with at least part of a finger or a touch pen.

12. The method of claim 11, wherein the gesture is determined as a closed curve generated of a certain size.

13. The method of claim 10, wherein the deformation information of the flexible display comprises information relating to at least one of stretching, shrinking, bending, folding, twisting, and spreading of the flexible display.

14. A method in an electronic device utilizing a flexible display, the method comprising:
displaying a camera mode screen;
determining a twisting degree of the flexible display; and
when the twisting degree exceeds a threshold, displaying at least one guide object in the camera mode screen.

15. The method of claim 14, further comprising when the twisting degree exceeds a second threshold, issuing a warning event.

16. The method of claim 15, wherein issuing the warning event comprises outputting at least one of a vibration, a Light Emitting Diode (LED), a text, an image, and voice data.

17. An electronic device comprising:
a flexible display; and
a processor for controlling to detect bending of the flexible display, to determine bending information corresponding to the detected bending, to obtain a plurality of images according to the determined bending information, and to generate a panorama image by combining the obtained plurality of images.

18. The electronic device of claim 17, wherein the processor controls to obtain twisting information of the flexible display when the plurality of images are captured, and to realign the plurality of images according to the obtained twisting information.

19. The electronic device of claim 17, wherein the processor controls to detect a gesture in a certain region of the panorama image, to determine a correction region corresponding to the detected gesture, and to correct part of the panorama image in the determined correction region according to deformation information of the flexible display.

20. A non-transitory storage medium storing instructions, which when executed by a processor, control the processor to perform a method comprising:
wherein the at least one operation comprises detecting bending of a flexible display, determining bending information corresponding to the bending, obtaining a plurality of images according to the determined bending information, and generating a panorama image by combining the obtained plurality of images.
